(19) United States
(12) Patent Application Publication
(10) Pub. No.: US 2007/0008570 A1
(43) Pub. Date: Jan. 11, 2007

(54) Image processing apparatus, program, and recording medium

(75) Inventors: Yuji Okamoto, Kyoto (JP); Naofumi Ueda, Kyoto (JP); Syoichiro Yoshiura, Nara (JP); Katsuyoshi Fujiwara, Osaka (JP)

Correspondence Address: EDWARDS & ANGELL, LLP, P.O. BOX 55874, BOSTON, MA, 02205, US

(73) Assignee: Sharp Kabushiki Kaisha, Osaka (JP)

(21) Appl. No.: 11/477,208

(22) Filed: Jun. 28, 2006

(30) Foreign Application Priority Data
Jul. 8, 2005 (JP) 2005-199925

(51) Int. Cl. G06K 15/00; G06F 15/00

(52) U.S. Cl. 358/1.14; 358/1.15

(57) ABSTRACT

An image processing apparatus is provided which is capable of adding an additional image having a high effect of discouragement to an input image when the input image is subjected to image processing, and requires less costs and less time in parts procurement for repair work. The image processing apparatus includes image information input portion that inputs image information, and an image adding portion that adds given visible additional image information for identifying the image processing apparatus to image information input by the image information input portion. The image adding portion has a determining portion that determines on whether or not to add the given additional image information to the image information input by the image information input portion.

### CROSS-NOTING PARAGRAPH

This Nonprovisional application claims priority under 35 U.S.C. §119(a) on Patent Application No. 2005-199925 filed in JAPAN on Jul. 8, 2005, the entire contents of which are hereby incorporated herein by references.

### FIELD OF THE INVENTION

The present invention relates generally to an image processing apparatus, a program, and a recording medium, and more particularly, to an image processing apparatus such as an image reading device, an image forming device, and an image recording device that is capable of adding additional image information in addition to image information consisting of a print image, etc., to a program to be installed in the image processing apparatus, and to a computer-readable recording medium recording the program therein.

### BACKGROUND OF THE INVENTION

A certain type of a conventional image forming device is capable of additional printing of the name of the manufacturer and/or the serial number of the device, which makes a copy, in a visible form in addition to a printed image. This additional information enables not only identification of the origin of copies when they are circulated, but also discouragement for fraudulent copying. Usually, such additional information is carved as a seal on a platen glass on a manuscript board, and the curved seal reduces the tone of a printed image on the corresponding spot into half, which is provided as a print result.

Some other conventional techniques to record additional information in a manuscript image are suggested, which include a technique to add information for identifying a device to a manuscript image (for example, see Japanese Laid-Open Patent Publication No. 6-70134), and a technique to add a watermark to a manuscript image (for example, see Japanese Laid-Open Patent Publication No. 2000-20271).

The image forming device described in Japanese Laid-Open Patent Publication No. 6-70134 comprises an image reading means that reads an image signal resulting from conversion of an image on a color manuscript, an image processing means that processes the image signal from the image reading means as a writing signal, an image forming means that forms an image on a recording sheet on the basis of an output image signal from the image processing means, an identification information generating means that generates identification information, such as the type and/or equipment identification number of the device, and an identification information adding means that adds the identification information from the identification information generating means to image information. According to the image forming device, the image information of the manuscript image is partly erased to form a white blank, to which the identification information adding means adds the identification information. Like other conventional image forming devices, this image forming device adds the identification information to identify the type-and/or equipment identification number of the device to be able to carry out tracing investigation when forged copies circulates. The image forming device employs such a method of information addition as described above so as not to heavily degrade an output image.

The printer controller described in Japanese Laid-Open Patent Publication No. 2000-20271 comprises a mark registering means that registers marks by linking them to output patterns, a mark selecting means that selects at least one mark out of the registered marks, and an image synthesizing means that superposing a selected mark onto image data. This printer controller superposes a mark (watermark) onto image data, and sends the image data to a printer.

However, the conventional technique of forming a carved seal on a platen glass on a manuscript board and executing half-tone printing requires each device to be provided with an individual carved seal representing an equipment identification number, etc. This leads to an increase in manufacturing costs, and makes quick repair work difficult to invite higher repair costs.

The device described in Japanese Laid-Open Patent Publication No. 6-70134 is free from the above problem that the device involving a carved seal on a platen glass has. The device of Japanese Laid-Open Patent Publication No. 6-70134, however, accompanies some restrictions resulting from an effort for offering images faithful to a manuscript. The restrictions include (1) limiting identification information added to a principle area for image printing (manuscript printing area) to invisible information colored in yellow, etc., and (2) allowing addition of visible identification information only to the area other than the manuscript printing area or to the vicinity of the outer edge of the manuscript printing area at the top/bottom and left/right thereof. Due to the restrictions (1), (2), a visible part of identification information turns out to be not so conspicuous when a user adds the identification information in carrying out printing on the device, thus the device offers little effect of discouragement. Besides, the method according to the device of Japanese Laid-Open Patent Publication No. 6-70134 does not take into consideration a case where a part of a manuscript that does not bear added identification information includes important information. Such a part can be cut out and copied easily. In this case, therefore, the device exerts a low effect of discouragement as the cutout part has no identification information.

The device described in Japanese Laid-Open Patent Publication No. 2000-20271 is free from the above problem that the device involving a carved seal on a platen glass has. The device of Japanese Laid-Open Patent Publication No. 2000-20271 employs a method of adding a mark irrelevant to the device in improved setting patterns. Addition of such a mark, however, may depend on a user's choice, thus by no means ensures discouragement for fraudulent copies. Since this method does not provide any check device, no consideration is given to a case where a part of a manuscript that does not bear added marks includes important information. Such a part can be cut out and copied easily, and, therefore, the device of Japanese Laid-Open Patent Publication No. 2000-20271 exerts a low effect of discouragement.

### SUMMARY OF THE INVENTION

An object of the present invention is to provide an image processing apparatus that is capable of adding an additional image having a high effect of discouragement to an input image when the input image is subjected to image processing and that requires less costs and less time in parts procurement for repair work, a program installed in the image processing apparatus, and a computer-readable recording medium recording the program therein.

Another object of the present invention is to provide an image processing apparatus that executes a given process on image information put into the image processing apparatus, the image processing apparatus comprising: an image information input portion that inputs image information; and an image adding portion that adds given visible additional image information for identifying the image processing apparatus to the image information input by the image information input portion, wherein the image adding portion has a determining portion that determines on whether or not to add the given additional image information to the image information input by the image information input portion.

Another object of the present invention is to provide an image processing apparatus, the image processing apparatus being an image reading device that reads a manuscript as image information, wherein the image information input portion is a portion that reads the manuscript on a manuscript transfer path.

Another object of the present invention is to provide an image processing apparatus, the image processing apparatus being an image forming device capable of executing a plurality of image processes as the given process, wherein the image forming device executes respective image processes after the image adding portion has added the given additional image information to the image information input by the image information input portion.

Another object of the present invention is to provide an image processing apparatus, the image processing apparatus being the image forming device capable of executing a plurality of image processes as the given process, wherein the image information input portion is the portion that reads the manuscript on the manuscript transfer path, the image forming device executes respective image processes after the image adding portion has added the given additional image information to the image information input by the image information input portion, and the determining portion determines on whether or not to add the given additional image information according to the types of the image processes.

Another object of the present invention is to provide an image processing apparatus, the image processing apparatus being the image forming device capable of executing a plurality of image processes as the given process, wherein the image information input portion is the portion that reads the manuscript on the manuscript transfer path, the image forming device executes respective image processes after the image adding portion has added the given additional image information to the image information input by the image information input portion, and the image adding portion has an additional information determining portion that determines additional image information allowed to be different according to the types of the image processes, the additional image information being provided as the given additional image information, and adds the additional image information determined by the additional information determining portion to the image information.

Another object of the present invention is to provide an image processing apparatus, wherein the image information input portion has a plurality of input portions that input image information.

Another object of the present invention is to provide an image processing apparatus, wherein the determining portion determines on whether or not to add the given additional image information according to an input portion operating as a source of input in the image information input portion.

Another object of the present invention is to provide an image processing apparatus, wherein the image adding portion has the additional information determining portion that determines additional image information allowed to be different according to the input portion operating as the source of input in the image information input portion, the additional image information being provided as the given additional image information, and adds the additional image information determined by the additional information determining portion to the image information input by the image information input portion.

Another object of the present invention is to provide an image processing apparatus, the image processing apparatus being the image reading device that reads the manuscript as image information, wherein the image information input portion has a first input portion that reads the manuscript on the manuscript transfer path, and a second input portion that reads the manuscript while the manuscript is placed on a manuscript board.

Another object of the present invention is to provide an image processing apparatus, the image processing apparatus being an image recording device that records the image information input by the image information input portion in a recording medium, wherein the image recording device records the image information input by the image information input portion in the recording medium after the image adding portion has added the given additional image information to the image information.

Another object of the present invention is to provide an image processing apparatus, the image processing apparatus being the image forming device capable of executing a plurality of image processes as the given process, wherein the image information input portion has a first input portion that reads the manuscript on the manuscript transfer path, and a second input portion that reads the manuscript while the manuscript is placed on the manuscript board, the image forming device executes respective image processes after the image adding portion has added the given additional image information to the image information input by the image information input portion, and the determining portion determines on whether or not to add the given additional image information according to the types of the image processes.

Another object of the present invention is to provide an image processing apparatus, the image processing apparatus being the image forming device capable of executing a plurality of image processes as the given process, wherein the image information input portion has a first input portion that reads the manuscript on the manuscript transfer path, and a second input portion that reads the manuscript while the manuscript is placed on the manuscript board, the image forming device executes respective image processes after the image adding portion has added the given additional image information to the image information input by the image information input portion, and the image adding portion has the additional information determining portion that determines additional image information allowed to be different according to the types of the image processes, the additional image information being provided as the given additional image information, and adds the additional image information determined by the additional information determining portion to the image information input by the image information input portion.

Another object of the present invention is to provide an image processing apparatus, wherein the additional information determining portion determines additional image information allowed to be different according to the types of the image processes and to the input portion operating as the source of input in the image information input portion, the additional image information being provided as the given additional image information.

Another object of the present invention is to provide an image processing apparatus, the image processing apparatus having a user authenticating portion that authenticates a user of the image processing apparatus, wherein the image adding portion adds information about the user authenticated by the user authenticating portion in addition to information for identifying the image processing apparatus, both pieces of information being provided as the given additional image information.

Another object of the present invention is to provide an image processing apparatus, wherein the image adding portion adds the information for identifying the image processing apparatus and the information about the user authenticated by the user authenticating portion, both pieces of information being provided as the given additional image information, so as to place both pieces of information close to each other.

Another object of the present invention is to provide an image processing apparatus, wherein the image adding portion has an additional information setting portion that allows an administrator of the image processing apparatus who is authenticated by the user authenticating portion to set contents of the given additional image information.

Another object of the present invention is to provide an image processing apparatus, wherein the contents of the given additional image information, the contents being set using the additional information setting portion, include information about the given process executed on the input image information in addition to the information for identifying the image processing apparatus.

Another object of the present invention is to provide a program to be installed in the image processing apparatus, the program causing a control portion of the image processing apparatus to function as the image adding portion.

Another object of the present invention is to provide a computer-readable recording medium recording the program therein.

### BRIEF DESCRIPTION OF THE DRAWINGS

FIG. 1 is a graphic diagram showing one structural example of an image processing apparatus according to one embodiment of the present invention;

FIG. 2 is a graphic diagram showing a structural example of an image forming device that is one example of the image processing apparatus according to the present invention;

FIG. 3 is a schematic sectional view showing one structural example of an image reading portion in the image forming device exhibited in FIG. 2;

FIG. 4 is a graphic diagram showing one structural example of an equipment control portion in the image forming device exhibited in FIG. 2;

FIG. 5 shows one example of a recording material subjected to a printing process in the image forming device of the present invention;

FIG. 6 shows another example of the recording material subjected to the printing process in the image forming device of the present invention;

FIG. 7 shows another example of the recording material subjected to the printing process in the image forming device of the present invention;

FIG. 8 shows still another example of the recording material subjected to the printing process in the image forming device of the present invention;

FIG. 9 shows still another example of the recording material subjected to the printing process in the image forming device of the present invention;

FIG. 10 shows still another example of the recording material subjected to the printing process in the image forming device of the present invention;

FIG. 11 is a graphic diagram showing one example of a mode-specified addition/non-addition judgment table used in the image forming device of the present invention; and

FIG. 12 is a flowchart for describing a series of steps of a copy process executed by the image forming device of the present invention.

### PREFERRED EMBODIMENTS OF THE INVENTION

An image processing apparatus according to the present invention is a device which executes a given process on image information put into the device. The image processing apparatus is provided in three forms consisting of (I) an image reading device that reads a manuscript as image information, (II) an image forming device at least having a function of forming an image on a recording material, such as recording paper, out of input image information, such as image data or electronic files created from readout from a manuscript, and (III) an image recording device that forms an image on a recording material, such as recording paper, from input image information, such as image data or electronic files created from readout from a manuscript, or that records the image information in a recording medium, such as HD, in a format of image file or electronic file such as PDF (Portable Document Format) file. The following description includes a separate explanation of each form (I) to (III) clearly expressed as such, in addition to a basic explanation of the image processing apparatus.

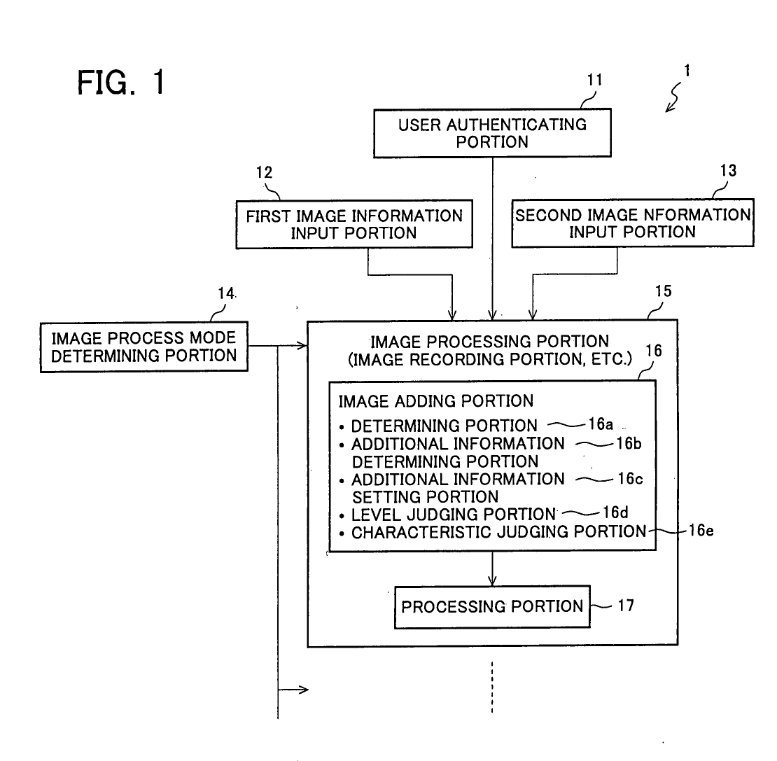

FIG. 1 is a graphic diagram showing one structural example of an image processing apparatus according to one embodiment of the present invention. In FIG. 1, reference numeral 1 stands for the image processing apparatus (image forming device), 11 for a user authenticating portion, 12 for a first image information input portion, 13 for a second image information input portion, 14 for an image process mode determining portion, 15 for an image processing portion, 16 for an image adding portion, 16a for a determining portion, 16b for an additional information determining portion, 16c for an additional information setting portion, 16d for a level judging portion, 16e for a characteristic judging portion, and 17 for a processing portion.

The image processing apparatus of the present invention includes at least one image information input portion (the first image information input portion 12 and/or the second image information input portion 13), the image adding portion 16, and the processing portion 17 that executes the given process in the image processing apparatus 1.

The image information input portion inputs image information, and preferably has two or more input portions, which are expressed as the first and second image information input portions 12, 13 in FIG. 1. These input portions 12, 13 may be image reading portions, such as scanners, that read a manuscript optically and generate image data, or receiving means that receive an electronic file from another portion, such as a PC (personal computer), via a network, etc, or readout/reception portion that read an electronic file out of an external recoding medium attached to the image processing apparatus 1 and receive the electronic file.

The image process mode determining portion 14 determines to use among one or plurality of the image processing portions 15 by mode that is chosen by a user. Respective portions of the image processing portion 15 correspond to a post-processing portion (a portion for generating image data from read image information, etc.) in an image reading portion related to the image reading device (I), correspond to an image forming portion related to the image forming device (II), and correspond to an image recording portion related to the image recording device (III), and each mode of the image processing portion 15 is provided with the processing portion 17. The image process mode determining portion 14, therefore, causes the image processing apparatus 1 to operate in a user-chosen mode among respective modes of the image processing portion 15, which includes a scan-to-file process or a scan-to-e-mail process in relation to the image reading device (I), a printing process ensuing scanning or file reception in relation to the image forming device (II), and a printing process or an electronic file generation/recording process ensuing scanning in relation to the image recording device (III). Basically, the processing portion 17 for each mode executes each image processing after the image adding portion 16 adds given additional image information to image information input by the image information input portion.

The image adding portion 16 adds given visible image information for identification of the image processing apparatus 1 to image information input by the image information input portion. The image adding portion 16 executes the information addition process preferably just before the final process on the input image information.

Preferably, the image adding portion 16 includes any one of or a plurality of portions consisting of the determining portion 16a that determines on whether or not to add given additional image information to image information input by the image information input portion, the additional information determining portion 16b that determines the additional image information, the additional information setting portion 16c that allows an administrator to set the additional image information, the level judging portion 16d that judges the confidential level of the input image information, and the characteristic judging portion 16e that judges the characteristic of the input image information. Each mean will be described in detail later.

With the determining portion 16a, the image processing apparatus 1 is allowed a choice of no addition of the additional image information. Besides, an image reading portion employing a CIS (Contact Image Sensing) method, which will be described later, is applicable to the image processing apparatus 1. The image processing apparatus according to the present invention, therefore, proves a device to feature such a technique that is different from the conventional technique of forming a carved seal, which is reproduced as a copy image without fail, on a platen glass.

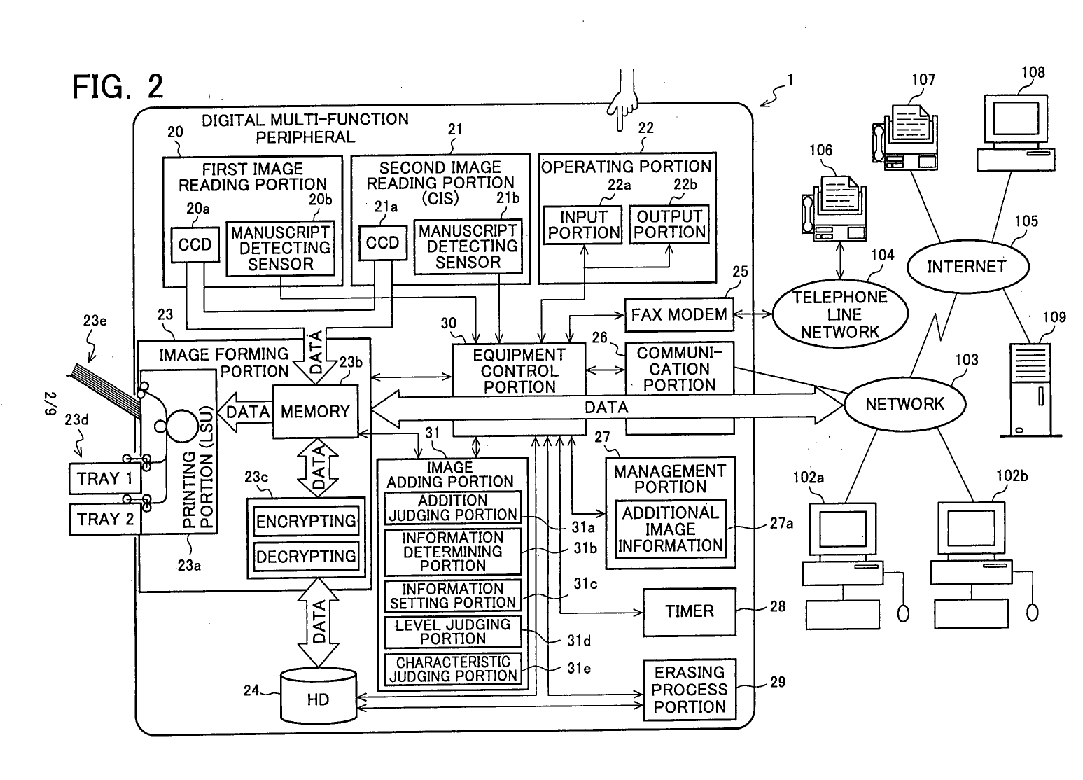

FIG. 2 is a graphic diagram showing a structural example of an image forming-device that is one example of the image processing apparatus according to the present invention. In FIG. 2, reference numeral 1 stands for a digital multi-function peripheral (digital compound machine) as one example of the image forming device, 20 for a first image reading portion, 21 for a second image reading portion, 22 for an operating portion, 23 for an image forming portion, 24 for a hard disc (HD) as one example of a storage device, 25 for a fax modem, 26 for a communication portion, 27 for an management portion, 28 for a timer, 29 for an erasing process portion, 30 for an equipment control portion, and 31 for an image adding portion.

The digital compound machine 1 shown in FIG. 2 includes the first image reading portion 20, the second image reading portion 21, the operating portion 22, the image forming portion 23, the HD 24, the fax modem 25, the communication portion 26, the management portion 27, the timer 28, the erasing process portion 29, the equipment control portion 30, and the image adding portion 31 that is characteristic of the present invention.

The digital compound machine 1 is connected to, for example, an external fax machine 106 via a telephone line network 104, as shown in FIG. 2. The digital compound machine 1 may also be connected to a plurality of terminal PCs 102a, 102b—via a network 103, such as LAN (Local Area Network), WAN (Wide Area Network), etc., and to an internet fax machine 107, an external PC 108, an external server 109, etc., which are outside the network 103, via the Internet 105. These network structures allow the digital compound machine 1 to transmit/receive a variety of data, and enable input of a variety of image information to the digital compound machine 1.

The operating portion 22 is made up of a touch panel, etc. which has an output portion (display portion) 22b that puts display on an operating screen, and an input portion 22a that allows a user to input various setting conditions and operation contents in reference to the display. The operating portion 22 allows the user to specify ordinary input data and a saving destination, to input authentication data (authentication code, etc.), and to set saving conditions. In addition, the operating portion 22 allows the user to execute setting for the choice of image process modes including printing, data saving, and scanning, according to the present invention, to execute input of various setting information including a designation of additional image information (including the color, position, number, and size of the information) a designation of addition or non-addition of the additional image information, and setting of a confidential level, and to execute other setting of a magnification ratio, of double-face printing, of automatic sheet selection, of a sheet type selection responding to various types of sheets such as A4, B5, etc., and of selection of a paper feeding tray but of paper feeding trays in a paper feeding portion 23d. In consideration of effective discouragement for fraudulent copying, preferably, only the administrator should be allowed to execute the setting related to the image addition process of the present invention (especially the setting of addition or non-addition) except setting for specifying a printing method for input image information.

The image reading portion 20, working according to an operation at the operating portion 22, causes a manuscript detecting sensor 20b to detect the presence or non-presence of a manuscript, causes a CCD (Charge Coupled Device) 20a to read the manuscript, and puts out image data created from the reading. Likewise, the image reading portion 21, working by the CIS method according to an operation at the operating portion 22, causes a manuscript detecting sensor 21b to detect the presence or non-presence of the manuscript, causes a CCD (Charge Coupled Device) 21a to read the manuscript, and puts out image data created from the reading. Both image data are sent to the HD 24 directly or via the image forming portion 23 when a filing process is executed, and to the image forming portion 23 for a printing process, and to the communication portion 26 for a data transmission process. The fax modem 25 is a modem that communicates by fax with the external fax machine 106. The communication portion 26 controls communication between the digital compound machine 1 and external equipment connected to the digital compound machine 1 via the network 103.

The image forming portion 23 temporarily stores image data read by the image reading portions 20, 21 and/or reception data (reception file) received by the fax modem 25 or the communication portion 26 in a memory 23b, and causes a printing portion 23a equipped with a laser scanner unit (LSU) to form an image on a medium such as a sheet material. In this process, printing data may be kept accumulated in the HD 24 until the entire data to be processed are stored in the HD 24, and then the stored data are read out into the memory 23b to allow the printing portion 23a to form an image. Sheets of papers are supplied from the paper feeding portion 23d, and are ejected out of an ejecting portion 23e after being printed with images. The image forming portion 23 can cause an encrypting process portion 23c to encrypt data, including image data, stored in the memory 23b and put the encrypted data in storage by the HD 24. Inversely, the image forming portion 23 can cause the encrypting process portion 23c to decrypt the encrypted data stored in the HD 24, and outputs the decrypted data to the external equipment via the memory 23b and the network 103 or causes the printing portion 23a to print out the decrypted data on the medium. The erasing process portion 29 erases some data stored in the HD 24 in order to maintain information security or ensure a proper memory capacity.

As described above, the digital compound machine 1 includes the operating portion 22 having the key input portion 22a and the display portion 22b, which allows a user to carry out an ID input operation in addition to an operation for specifying each function of the compound machine 1. Aside from the portions for ID input, the digital compound machine 1 may be provided with an ID card reader that reads out information contained in an ID card inserted therein. As described above, the digital compound machine 1 preferably has a user identifying portion, such as the above authenticating portion. The authenticating portion can be any portion as far as it authenticates an ordinary user or an administrative user based on user information and permits use of the compound machine 1. Accordingly, the digital compound machine 1 narrows down users through the authenticating portion. The digital compound machine 1 is capable of two-way data communication with the equipment connected to the compound machine 1 (terminal PCs 102a, 102b, etc.) through the communication portion 26.

The equipment control portion 30 is a main control portion connected to each portion described above. The equipment control portion 30 controls the operation of the digital compound machine 1, including data exchange between each portion, comprehensively, referring to management data from the management portion 27 and a timer time from the timer 28. The management portion 27 manages, for example, folder information, saving condition information, the IP address of the compound machine 1, etc., which are stored in the HD 24. The management portion 27 also retains and manages additional image information related to the present invention so that the image adding portion 31 can read out the additional image information into the memory 23b via the equipment control portion 30 in accordance with setting on use of each additional image information. The timer 28 counts a time span of a standby state of the compound machine 1, and informs the equipment control portion 30 of the time span.

Control by the equipment control portion 30, for example, proceeds as the following. The operating portion 22 informs the equipment control portion 30 of a copy request, various recording conditions, etc. given by input from a user. In response, the equipment control portion 30 displays the operating status, etc. of the digital compound machine 1 on the monitor screen of the display portion 22b of the operating portion 22, and instructs the image forming portion 23 to execute a printing process, which accompanies control by the control portion 30 over addition of additional information and an alteration in the pattern of additional information including its color or size. Upon executing filing, the equipment control portion 30 converts external transmitted data transmitted from the PC 102a, etc. or readout data from the image reading portions 20, 21, referring to folder information and/or saving condition information in the HD 24 through the management portion 27, and saves converted image data in a specified folder in the HD 24.

The image adding portion 31, the main characteristic of the present invention, is a section corresponds to the image adding portion 16 shown in FIG. 1. The image adding portion 31 adds given additional image information, which is visible and identifies the compound machine 1, to image information input from the image reading portions 20, 21, the communication portion 26, etc. Further explanation of the image adding portion 31 will be given later, together with a description of examples of additional image information. The image adding portion 31 includes any one of or a plurality of portions consisting of an addition judging portion 31a that judges addition or non-addition of additional image information as described in relation to the determining portion 16a, an information determining portion 31b corresponding to the additional information determining portion 16b, an information setting portion 31c corresponding to the additional information setting portion 16c, a level judging portion 31d corresponding to the level judging portion 16d, and a characteristic judging portion 31e corresponding to the characteristic judging portion 16e. The image adding portion 31 is also under control by the equipment control portion 30 as described above.

The image adding portion 31 executes a process as the following according to a command from the equipment control portion 30. For example, an image processing portion (not shown) keeps image information (printing data) input from the image reading portion 20 or 21 in the buffer memory 23b and develops the kept information to generate print image data. The image processing portion is connected to the equipment control portion 30, and receives an instruction signal from the equipment control portion 30 to process data entering the memory 23b in accordance with information provided by the signal, at which additional image information is added to the data according to a need. Upon executing an image addition process, the image adding portion 31, following the instruction signal from the equipment control portion 30, reads additional image information 27a, which is to be added to the print image data in the memory 23b, out of the management portion 27 for use in the process, and generates additional image data. The generated additional image data is synthesized with the print image data in the memory 23b, and the synthesized data is sent to a printer (image forming portion 23), which prints out the synthesized data on an image carrier such as a sheet.

The configuration of the digital compound machine 1 and the connection pattern between compound machine 1 and external equipment according to the present invention are not limited to the example described above. Each portion of the compound machine 1 is not necessarily a hardware unit. A program to cause the compound machine 1 to assume the function of some portions may be installed in the compound machine 1, where the program is incorporated into the equipment control portion 30, a control portion in the image adding portion 31, or a control portion in the printing portion 23a (or part of the program is incorporated into the management portion 27). The program is executed by a processor to provide the function substituting for some portions easily. Such a program, in many cases, is installed as firmware, for example, in the equipment control portion 30, the image adding portion 31, the printing portion 23a, the management portion 27, etc. Data for use in the firmware is also stored in those portions.

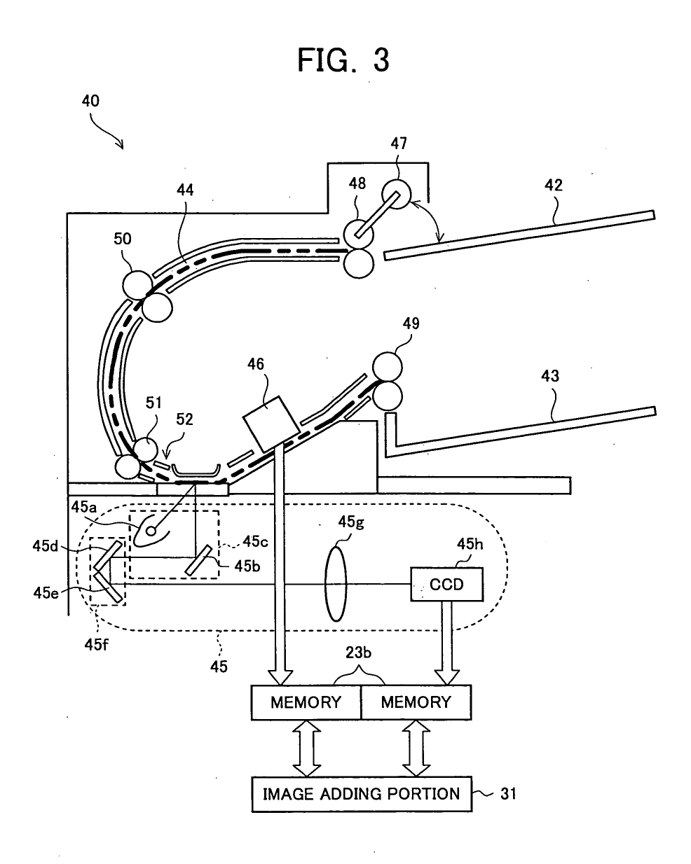

The following is a supplemental explanation of the image reading portions 20, 21. FIG. 3 is a schematic sectional view showing one structural example of the image reading portion in the image forming device exhibited in FIG. 2, that is, a schematic sectional view showing one structural example of the image reading device according to the present invention. An image scanner unit 40 exhibited in FIG. 3 is one example of the image reading device equipped with both first and second image reading portions 20, 21.

The image scanner unit 40 has a SPF (Single Pass Feeder), and is capable of reading images on both faces of a manuscript as the manuscript is transferred through a manuscript transfer path one time. The image scanner unit 40 has the manuscript transfer path 44 extending from a manuscript bearing tray 42 to a manuscript ejecting tray 43, and the manuscript is transferred on the manuscript transfer path 44 from the manuscript bearing tray 42 to the manuscript ejecting tray 43. A pickup roller 47 and fanning rollers 48 are arranged at the upstream side end of the manuscript transfer path 44 in a manuscript transfer direction, where the pickup roller 47 and the fanning rollers 48 feed manuscripts stacked on the manuscript bearing tray 42 into the manuscript transfer path 44 one by one. Ejecting rollers 49 are arranged at the downstream side end of the manuscript transfer path 44 in the manuscript transfer direction, where the ejecting rollers 49 eject the manuscript transferred through the manuscript transfer path 44 onto the manuscript ejecting tray 43.

On the manuscript transfer path 44, a CCD method image reading unit 45 and a CIS method image reading unit 46 are arranged in increasing order along the manuscript transfer direction. The CCD method image reading unit 45 reads an image on the first face of a manuscript, while the CIS method image reading unit 46 reads an image on the second face of the manuscript. The image reading unit 45 has a demagnification optical system that demagnifies to aggregate an image via a focus lens, which will be described later. The CIS method image reading unit 46, which is not detailed here, is provided with CCD charge-transfer method line sensors that are installed to cover the width of a manuscript.

Each image reading unit 45, 46 has an exposure lamp, an inverter circuit that turns on the exposure lamp, and a CCD transfer method image sensor that detects an image electrically by detecting light emitted from the exposure lamp and reflected by the manuscript and converting detected light into electric charges via photodiodes (FD), and transferring the electric charges via a CCD. The first image reading unit 45 includes a first scanning unit 45c having a first-exposure lamp 45a and a first reflective mirror 45b, a second scanning unit 45f having a second reflective mirror 45d and a third reflective mirror 45e, an image focus lens 45g, and a CCD sensor 45h. Light emitted from the exposure lamp 45a and reflected at the first face of the manuscript is reflected by the first, second, and third reflective mirrors 45b, 45d, 45e sequentially, and falls onto the image focus lens 45g, which then focuses incident light into an image on the CCD sensor 45h. The CCD sensor 45h turns light focused via the image focus lens 45g into image data by a photoelectric conversion process, and reads the image data.

Each scanning unit 45c, 45f is displaceable in a subscanning (vertical scanning) direction along a platen glass, on which the manuscript is placed when the image on the manuscript is read by a manuscript fixing method. The first image reading unit 45 displaces the first and second scanning units 45c, 45f in the subscanning direction to read the image on the manuscript placed to be fixed on the platen glass, thus obtains image data of the image on the manuscript. At an image reading position, a separate platen glass is also provided, and light emitted from the exposure lamp 45a passes through this platen glass and falls onto the manuscript. At the image reading position, the wall surface of the manuscript transfer path 44 that faces the separate platen glass is provided with a standard white board used for shading correction. The first image reading unit 45 is, therefore, structured to be able to serve for both the manuscript moving method and a manuscript fixing method. This enables the image scanner unit 40 to read the image on the manuscript by the manuscript fixing method without having a separate image reading portion for the manuscript fixing method in addition to an image reading portion for the manuscript moving method.

Transfer rollers 50, 51, which are driven by a manuscript transfer motor, and a curved portion 52 of the manuscript transfer path 44 are arranged in increasing order in the manuscript transfer direction on the upstream side relative to the CCD method image reading unit 45. In contrast, no transfer rollers are arranged between the CCD method image reading unit 45 and the CIS method image reading unit 46, where the manuscript transfer path 44 is formed substantially linear. Transfer rollers, however, may be arranged between the image reading units 45, 46 in some cases.

While the image reading device (or the image reading unit in the image forming device or the image recording device) is described as the image scanner unit 40, the unit configuration of the image reading device is not limited to that of the image scanner unit 40 exhibited here. The number of the image reading units is not restricted, and one unit is allowable. The demagnification optical system included in the first image reading unit 45 shortens a light path for image reading, which enables miniaturization of the image scanner unit 40. To utilize this advantage, a unit having a similar demagnification optical system may be employed as the second image reading unit 46 instead of a contact image sensor (CIS) that eliminates a need of a light path.

The image processing apparatus of the present invention does not employ such configuration that additional information is carved physically on a platen glass, so that the processor can add additional image information to image information that is read by line sensors from a manuscript on transfer in the same way as in the image reading unit 46. This means that additional image information can be added in a form of buried electronic data to such image information that is read from a manuscript on transfer, to which a conventional method of reading a pattern on a ground glass cannot apply. The image processing apparatus according to the present invention, therefore, eliminates a problem of a conventional device that it requires costs and time to replace a platen glass when it breaks. The device shown in FIG. 3 allows addition of additional image information also to image information read by the image reading unit 45. For the image processing apparatus of the present invention, therefore, inputting image information by means of reading a manuscript on its transfer path is preferable.

The image reading device in the form of (I) usually has the image data processing portion that generates image data input by the image reading unit and that transfers or records the image data, and, in addition, has the image adding portion 16, which is the main characteristic of the present invention. The image adding portion 16 adds given additional image information to input image data, that is, adds the given image information to the image data processed by the image data processing portion. Being in the form of (I) gives the image reading device only the condition that input image information is limited to information read out of a manuscript, and various applications described as to the form of (III) are available for the process involving the image adding portion 16.

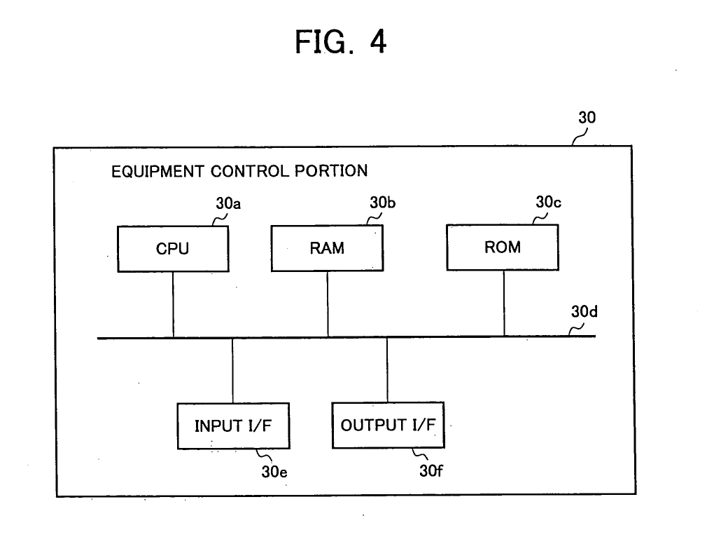

The following is a supplemental explanation of the equipment control portion 30. FIG. 4 is a graphic diagram showing one structural example of the equipment control portion 30 in the image forming device exhibited in FIG. 2. The equipment control portion 30 comprises, for example, a CPU (Central Processing Unit) 30a, a memory such as RAM (Random Access Memory) 30b, a ROM (Read Only Memory) 30c, an input I/F (Interface) 30e, an output I/F 30f, and a bus 30d which interconnects the above components.

The ROM 30c holds a basic control program and control programs for the image addition process according to the present invention, the programs being held as firmware, and various types of data for conversion processes (setting table, color alteration table, etc.). As mentioned before, these programs and data may be stored in respective portions in a distributed manner. The programs and data according to the present invention include a program for adding additional information to image information read by the image reading portions 20, 21, a program for altering the additional information according to the size and/or color of a recording sheet, and a color altering table bearing compensation values for the color of the recording sheet against each basic color.

These programs are installed in the digital compound machine 1 having processors such as the CPU 30a, and are executed by the processors (mainly by the CPU 30a) in the digital compound machine 1. The programs at least include a program for the CPU 30a to execute steps for the image addition process according to the present invention. The programs according to the present invention, therefore, are installed in the image processing apparatus (image forming device, image reading device, image recording device, etc.) having the control portion including the processors, etc., and cause the control portion of the image processing apparatus to function as the image adding portion 16.

Among the programs, the control program for the image addition process according to the present invention is read out of the ROM 30c into the RAM 30b by the CPU 30a. The control program then drives the CPU 30a so as to add given additional image information, which is different from input image information, to the input image information sent from the image reading portions 20, 21 via the input I/F 30e for image formation, and put out the image information bearing the additional image information to the image forming portion 23 (and the image reading portions 20, 21) forming a monochrome image (or a color image if the compound machine 1 is capable of color image formation) on a recording sheet via the output I/F 30f. In this process, the additional image information is input from the HD 24, etc. outside the equipment control portion 30 via the input I/F 30e, or read out of the ROM 30c where the additional image information is stored beforehand. The information handled in this process is input by the input I/F 30e, accumulated temporarily in the RAM 30b upon being processed, and then stored in the HD via the ROM 30c or the output I/F 30f. The CPU 30a reads out, modifies, and writes into the stored information according to a need.

The control program for the image addition process can be provided in a form of a computer-readable recording medium having the program recorded thereon. Such a recording medium includes a CD-ROM, magnetic optical disc, DVD-ROM, flexible disc, flash memory, ROM, RAM, etc. The control program recorded in the above recording medium for circulation enables a device to attain the function provided by the invention easily. To execute the image addition function according to the present invention, each corresponding control program is stored in the image reading device, the image forming device, and the image recording device separately, and is read out when necessary.

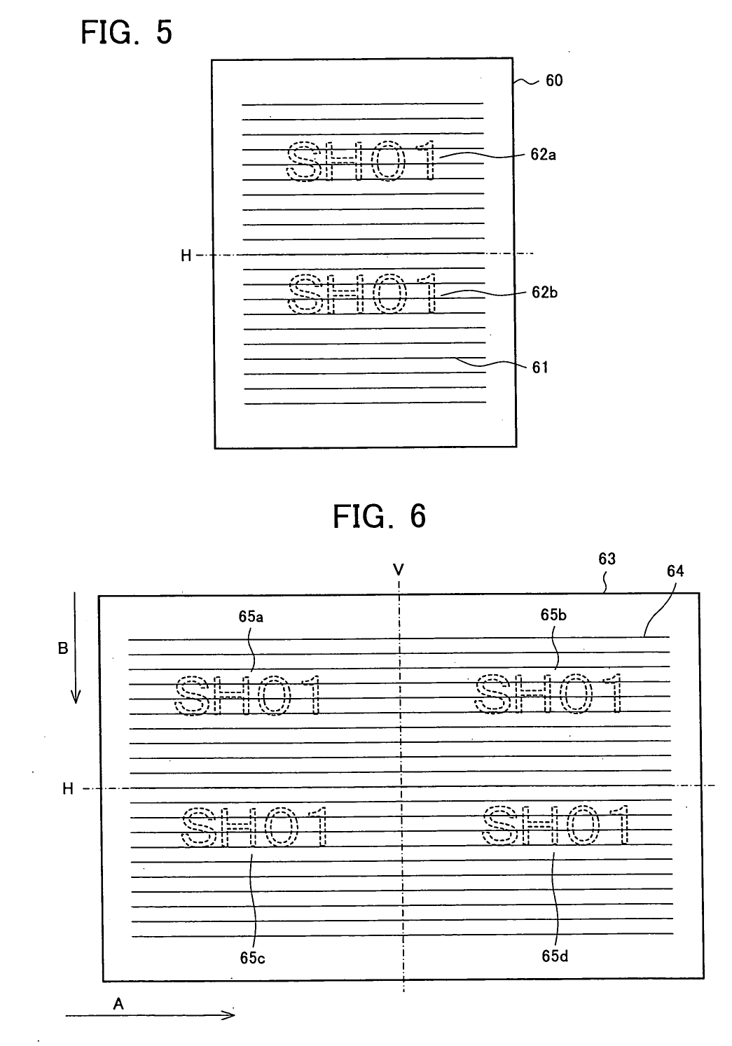

Various embodiments of the present inventions applicable to the above configurations of the devices will be described in the following. FIGS. 5 to 10 illustrate various examples of recording materials subjected to a printing process in the image forming device according to the present invention.

Additional image information according to the present invention means, for example, data for printing such information as visible watermarks 62a, 62b indicating a device name (“SH01” in this example) on a recording material 60, together with a printing result 61 based on input image information, as shown in FIG. 5. A watermark defined according to the present invention means such mark that is printed as a background (incorporated as a background image in an electronic file) on a recording material at least in a visually recognizable manner. The mark may be characters expressed in a form of dotted lines or chain lines. The mark, illustrated here as the watermarks 62a, 62b, is formed at a proper position, in a proper number, and at a proper size so that a part of a recording material that is expected to bear printed image information important to discouragement for fraudulent copying is not cut out and circulated separately. While examples of a plurality of watermarks printed on the same recording material are exhibited in FIGS. 5 to 10, a watermark may take a form of a single string of characters arranged circularly.

As the result of such addition of additional image information, for example, a person can visually recognize the fact that an image has been read with a scanner and printed out on a copier “SH01” when seeing a printed recording material marked with “SH01”, or the fact that scanning has been made using a scanner “SH01” when seeing the background of a recorded electronic file is marked with “SH01”.

In the form of (II), the image forming device, as the compound machine shown in FIG. 2, may be capable of executing a plurality of image processes including the image forming process. The image forming device is at least capable of executing respective image processes, including the image forming process, after the image adding portion 16 has added given additional image information to image information input by the image information input portion. The image forming device has the image recording portion as one portion to execute an image process. The image recording portion forms an image out of the image information with the additional image information resulting from addition of the given additional image information by the image adding portion 16, and records the formed image on a recording material.

The image information input portion of the image forming device reads a manuscript on its transfer path, which is the same way as the CIS method image reading unit 46 shown in FIG. 3 does. This ensures the effect provided by the image addition process according to the present invention that can be executed without a prerequisite of placing a recording material on a manuscript board. The image adding portion 16 has the determining portion 16a, which determines on whether or not to add given additional image information according to the type of an image process. This allows such setting (by an administrator) that information addition is carried out when a mode determined by the image process mode determining portion 14 is a printing process mode, and is not carried out when the determined mode is a mode for creation/storage of an electronic file.

The image adding portion 16 also has the additional information determining portion 16b, and adds additional image information determined by the additional information determining portion 16b to input image information. The additional information determining portion 16b in this form allows given additional image information to be different according to the types of image processes when determining the given additional image information. As a result, the image adding portion 16 adds different pieces of given additional image information according to a case where a mode determined by the image process mode determining portion 14 is the print process mode, and to a case where the determined mode is the mode for creation/storage of an electronic file. For example, when a determined mode is the print process mode, the serial number of a printing unit becomes the additional information. On the other hand, when the determined mode is the mode for creation/storage of an electronic file, the serial number of an HD becomes the additional information.

Preferably, the image information input portion has a plurality of input portions for inputting image information when incorporated in the devices in the forms of (I) to (III), as shown in FIGS. 1 to 3 and will be described later.

The image processing apparatus, as an exemplary case, includes the first image information input portion 12, the second image information input portion 13, and the image adding portion 16. The image adding portion 16 adds given visible additional image information, which identifies the image processing apparatus, to image information input from the first image information input portion 12 and/or the second image information input portion 13 preferably just before the final image process. The image processing apparatus also has an input control portion that executes control for switchover between input from the first image information input portion 12 and that from the second image information input portion 13 according to a need. The image adding portion 16 has the determining portion 16a that determines on whether or not to add the given additional image information to the image information input from the first and second image information input portions 12, 13.

Preferably, in the image processing apparatus having a plurality of image information input portions, the determining portion 16a determines on whether or not to add the given additional image information according to an input portion operating as the source of input (input portion to which image information input has been completed or is in progress) among the image information input portion.

When the image processing apparatus is in the form of (I) the image reading device and has a plurality of image information input portions, those input portions preferably consist of the portion for reading a manuscript placed on a manuscript board, the portion being illustrated in relation to the first image reading portion 20 shown in FIG. 2, and the portion for reading the manuscript on its transfer path, the portion being illustrated in relation to the second image reading portion 21 shown in FIG. 2. The first image reading portion 20 is described as a portion that has both portions for reading the manuscript placed on the manuscript board and for reading the manuscript on its transfer path. The image reading device provided with these portions allows a user to switch on a mode for reading a manuscript image in the course of manuscript transfer and on a mode for reading the manuscript image from the manuscript supported on the manuscript board. This mode switching enables execution of mode-specified processes by the determining portion 16a and/or the additional information determining portion 16b.

When the image processing apparatus is in the form of (III) the image recording device and has a plurality of image information input portions, image information input by those input portions is recorded in a recording medium. The recording medium mentioned here includes not only a recording material such as recording paper or recording sheet, but also a recording medium for recording data electrically, magnetically, or optically, such as HD, various types of disk media, etc. The image recording device is, therefore, provided in a form of a recording medium driver, such as a printer, HD drive, etc., or in a form of a filing device (built in a PC) that has the driver and generates/files electronic files. The image recording device is capable of recording the input image information in the recording medium after the image adding portion 16 has added given additional image information to the input image information. When an electronic file is recoded in an HD, etc., however, the additional image information must be inseparable from the electronic file upon recording. The image recording device provided with a plurality of input portions allows a user to switch on, for example, a file generation mode and on a printing mode. This mode switching enables execution of mode-specified processes by the determining portion 16a and/or the additional information determining portion 16b.

When the image processing apparatus is in the form of (II) the image forming device and has a plurality of image information input portions, the image forming device is preferably capable of executing a plurality of image processes including the image forming process as the compound machine shown in FIG. 2 is. This image forming device is at least capable of executing respective image processes, including the image forming process, after the image adding portion 16 has added given additional image information to image information input by the image information input portion. The multifunctional image forming device provided with a plurality of input portions allows a user to switch on, for example, a scanner reading mode, on a file receiving mode, and on a fax receiving mode. This mode switching enables execution of mode-specified processes by the determining portion 16a and/or the additional information determining portion 16b.

The above image forming device may be structured to have a plurality of image information input portions consisting of the portion for reading a manuscript on its transfer path and, the portion for reading the manuscript placed on the manuscript board. The multifunctional image forming device provided with such input portion allows a user to switch on, for example, an automatic manuscript feeding/reading mode, and on a manuscript board reading mode, in addition to the above mode-specified processes, by making different manuscript setting. This mode switching enables execution of mode-specified processes by the determining portion 16a and/or the additional information determining portion 16b. Specifically, the determining portion 16a is allowed to determine on whether or not to add additional image information according to the type of an image process and to the source of input, and the additional information determining portion 16b is allowed to choose and determine additional image information to add according to the type of an image process and to the source of input.

As described above, the image processing apparatus according to the present invention allows the determining portion 16a to determine on whether or not to add additional image information according to the type of an image process and to the source of input, and allows the additional information determining portion 16b to determine additional image information to add according to the type of an image process and to the source of input. In practical application, for example, the following rules (a) to (c) may be established for a section or department in an office where the image processing apparatus is installed, and the specifications or setting of the device is decided according to the rules.

(a) Add additional image information when making a copy, but add no additional image information for fax transmission, because a faxed document presents an unclear image and bears a number indicating a sender. Print out a received fax document without additional image information because the unclear image of the printed fax document presents clear evidence of copying when the document is copied. (b) Print out a document without additional image information and copy a document with additional image information when using the device as a network printer, because specific setting with a PC, such as setting for file printing authority, can be made. (c) Add additional image information to a material that can be filed as clearly as the original manuscript or transmitted via a network when carrying out filing for creating an electronic file, such as PDF (scan-to-file), or sending an e-mail with attached readout data (scan-to-mail).

Preferably, the image processing apparatus according to the present invention has the user authenticating portion 11 for authenticating a user of the device, as shown in FIGS. 1, 2. The authenticating portion 11 enables the following processes.

As a first process, as shown in FIG. 10, the image adding portion 16 adds information on a user authenticated by the authenticating portion 11 (user name, ID 82b, ID 83b, etc.) as well as information for identifying the image processing apparatus, such as serial numbers 82a, 83a. These pieces of information are added as given additional image information. Preferably, the image adding portion 16 so adds the information on the user authenticated by the authenticating portion 11 and the information for identifying the image processing apparatus, such as the serial numbers, as to place both pieces of information close to each other. This arrangement prevents cutting out of the user-related information as much as possible.

As a second process, an administrative user is allowed to execute various setting for an image addition process. For that, the image adding portion 16 has the additional information setting portion 16c, which allows an administrator of the image processing apparatus, who is authenticated by the user authenticating portion 11, to make setting for the contents of given additional image information and/or addition or non-addition of the additional image information. The user authenticating portion 11 is used not only for the execution of user authentication in advance, but may also be used as a portion for confirming the identity of the administrator when the administrator makes setting for addition of the given additional image information to image data, using the additional information setting portion 16c. The administrator carries out the setting on an operation panel, and set information is stored in the management portion (management portion 27 shown in FIG. 2), from which the information is read out when necessary.

The contents of the given additional image information set with the additional information setting portion 16c may include information about given processes executed on input image information, in addition to information for identifying the image processing apparatus. Besides the information on the user authenticated by the authenticating portion 11, the contents may also include process section information, process date information, the contents of magnification/demagnification processes, and other information related to image data processes. In other words, the contents of the additional image information preferably contain plenty of visually recognizable information effective in tracing the origin of copies.

When the image processing apparatus in the form of (II) the image forming device has the image recording portion 15 as a means for executing the image process, the image recording portion 15 forms an image from image information to which given additional image information has been added by the image adding portion 16, and records the formed image in a recording material. The following is a detailed description of the above case, particularly, a description of the position, etc., of an additional image added according to the additional image information. The description includes applications involving the above mentioned various types of processes. The image recording portion 15, therefore, may have the determining portion 16a, and printing of the additional image is not imperative.

Preferably, given additional image information is such information that can be recorded at a given position on a recording material, where the additional image information overlaps image information input by the image information input portion as a whole, as shown in FIGS. 5 to 10. The image adding portion 16 adds a plurality of pieces of additional image information to be recorded or adds additional image information that provides additional images at a plurality of spots. The additional image information may provide additional images thick enough to be recognizable even after secondary copying so as to provide a sufficient effect of discouragement.

As shown in FIG. 5, additional images 62a, 62b added according to given additional image information are so recorded in a plurality of divided areas, for example, in respective areas divided by a line H on a recording material 60 that each additional image 62a, 62b is arranged at the same position in each divided area. Likewise, as shown in FIG. 6, additional images 65a to 65d added according to given additional image information are so recorded in respective areas divided by a line H in an arrowed direction B and by a line V in an arrowed direction A on a recording material 63 that each additional image 65a to 65d is arranged at the same position in each divided area. To permit such recording, the given additional image information is provided as information about the additional images as many as the divided areas.

Addition of such additional images ensures the effect of discouragement even if the recording material is cut in the middle and a cut piece is distributed, because both cut pieces contains discouragement information printed in each area. Following this concept, the recording material may be divided not only horizontally as shown in FIG. 5, but also vertically, or both horizontally and vertically. In addition, the number of divided areas is not limited to two, and three or more divided areas are permissible. Each additional image is preferably printed near the center of each divided area, and, as one method, one additional image may be printed near the center of a divided area in relative to the area of the divided area regardless of the shape thereof. Various patterns of division of the recording material, therefore, are possible including diagonal one. As described above, at least two pieces of given image information are added preferably at opposite positions on the recording material bearing the recorded image. Even one piece of additional image information suffices if it offers such an additional image that occupies a large area of the recording material in a form of a string of characters arranged in circle, etc., and that is added at a position where the additional image overlaps input image information (position where the additional image indicates the whole of an input image).

When the image processing apparatus has a portion for recording images on both faces of a recording material as the image recording portion 15, as shown in FIGS. 2, 3, the image adding portion 16 preferably adds given additional images 72a, 72b and 74a, 74b to an image 71 recorded on the first face of the recording material 70 and an image 73 recorded on the second face of the same, respectively, as shown in FIG. 8.

Further, the image adding portion 16 preferably adds given additional image information to be recorded on both faces of the recording material 70 so as to provide additional images shifted to each other on the back/front of the recording material 70, as illustrated by the additional images 72a, 72b and 74a, 74b. This arrangement prevents the additional images on both faces from overlapping each other, reduces an area that can be cut away for circulation without allowing tracing of the origin of the information, thus improves the effect of discouragement.

The image adding portion 16 (or image recording portion 15) preferably has the level judging portion 16d for judging the confidential level of image information input by the image information input portion. The image adding portion 16 determines the form of given additional image information (including the number, position, thickness, size, etc. of the information) according to a confidential level judgment given by the level judging portion 16d. For example, when the image processing apparatus is in the manuscript board mode, a book copy process is executed in many cases, which gives an assumption that the confidential level of image information is low. The image information read out of the manuscript board is, therefore, considered to low in confidential level, which permits a process of non-addition of additional image information.

Besides a case where the form of additional image information is fixed according to input image information, the form of additional image information may be fixed according to the type of a recording material. The image adding portion 16, therefore, preferably has a portion for holding the additional image information that corresponds to a recording material handled in the image forming device so as to use the corresponding image information as the given additional image information. Accordingly, the image adding portion 16 adds the held additional image information according to the recording material that is the object of a recoding process by the image recording portion 15.

Correspondence to a recording material may mean correspondence to the size (B5, A4, etc.) of a recording material handled in the image forming device. In this case, additional image information corresponding to the size of each recording material is held, and the additional image information corresponding in terms of size to an actually used recording material is put in use. In addition to the method of preparing additional image information corresponding to the size of recording materials, such a method is available that the image adding portion 16 changes a given position for addition of additional image information according to the size of a recording material. For example, the given positions of the additional images 62a, 62b on the recording material 60, which is an A4 sheet, B5 sheet, etc., as shown in FIG. 5, are made different from the given position of the additional images 65a, 65b, 65c, 65d on the recording material 63, which is an A3 sheet, B4 sheet, etc., as shown in FIG. 6. A slight change in the given position suffices as far as position setting is made for the effect of discouragement. The number of additional images is also changed in the examples shown in FIGS. 5, 6, which indicates the fact that the size or number of additional images necessary for the effect of discouragement needs to be increased as the size of a sheet increases.

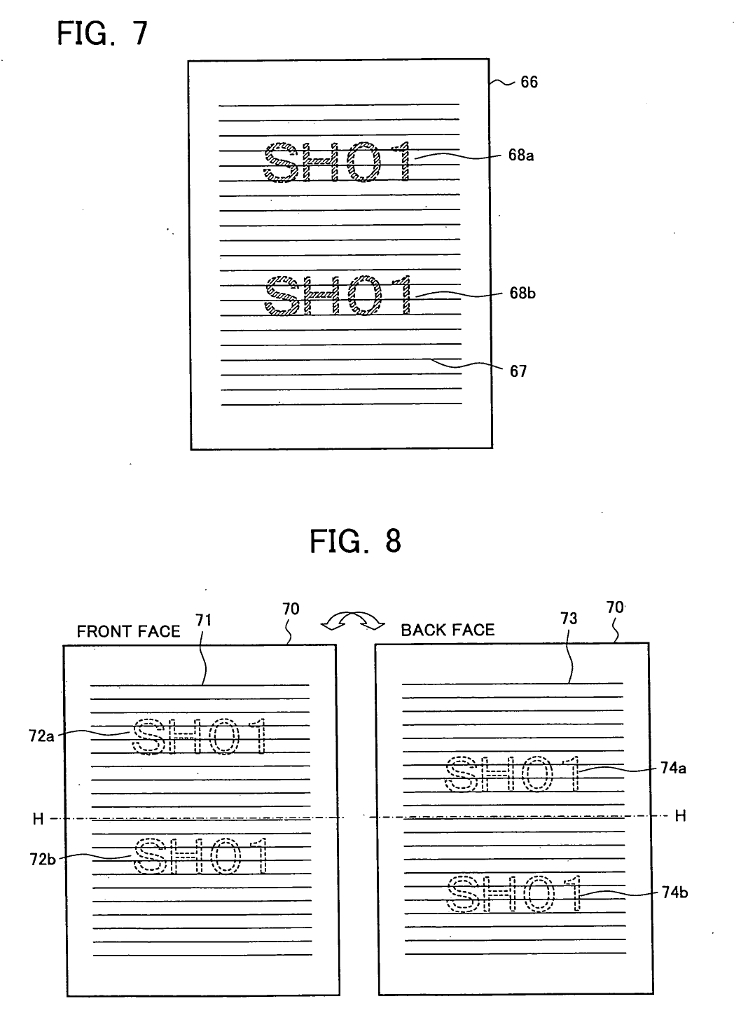

Correspondence to a recording material may mean correspondence to the color of a recording material handled in the image forming device. In this case, additional image information corresponding to the color of each recording material is held, and the additional image information corresponding in terms of color to an actually used recording material is put in use. To provide the additional image information corresponding in terms of color to the recording material, only giving the additional image information a color different from that of the recording material ensures a sufficient effect, so that the portion for holding additional image information holds the additional image information that has a visible color corresponding to the color of the recording material handled in the image forming device. Accordingly, the additional image information is provided with a color different from that of the recording material in terms of thickness, hue, brightness, chroma, etc., to the extent that a sufficient effect of discouragement is ensured. When the image forming device produces only the monochrome images, the effect of discouragement is ensured by preparing the additional image information offering a difference in brightness (thickness). When the image forming device is capable of producing color images, the additional image information offering a difference in colors is prepared. For example, when the recording material 60 shown in FIG. 5 is colored in white, the additional images 62a, 62b on the recording material 60 are colored in light gray. Likewise, when the recording material 66 shown in FIG. 7 is colored in pink, the additional images 68a, 68b on the recording material 66 are colored in thick gray. The additional image information may be provided with a color distinct or thick enough to offer a strong effect of discouragement that makes the additional image information recognizable even if it is subjected to secondary copy. A color that appears as a copied result after copying is preferable in discouraging secondary copy.

In providing the additional image information corresponding in terms of color to the recording material, the shape of an additional image may be changed according to the color of the recording material. For example, pieces of additional image information consisting of different strings of characters may be added to a photograph sheet and to a regular sheet separately.

Information of the color of a recording material is provided by user input, such as setting for the paper feeding tray, colors, etc. As another form in providing the information of the color of the recording material, the color image forming device may have a color distinguishing portion for distinguishing the color of the recording material upon paper feeding. For example, when the image forming device has a plurality of paper feeding trays, a charge coupled device (CCD) is set at the position where the recording material passes through constantly, and the CCD distinguishes the color of the recording material at the position.

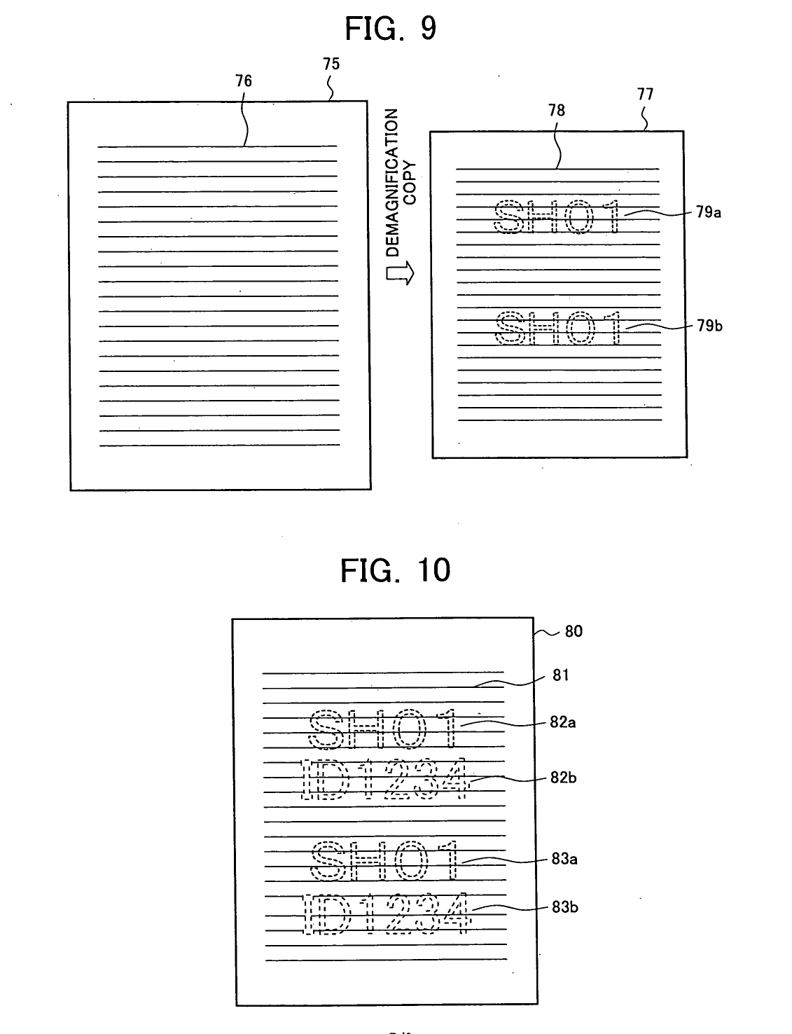

Preferably, the image recording portion 15 has an image converting portion for converting the form of an image when image information input by the image information input portion is recorded. The image converting portion converts the form of the image by magnification, demagnification, aggregation, etc. The image adding portion 16 adds additional image information held in the image adding portion 16 according to a recording material that is the object of recording by the image recording portion 15 even when the form of the image is converted by the image converting portion. For example, when equal magnification ratio printing is carried out for a manuscript 75 printed with an image 76, as show in FIG. 9, addition of additional images is carried out in the same manner as the additional images 62a, 62b on the recording material (A4 size) 60 as shown in FIG. 5. When an image 78 is formed on a recording material (B5 size) 77 in demagnification printing, as shown in FIG. 9, additional images 79a, 79b reduced at the same ratio as the image 78 are added for printing. To afford such additional images, the image adding portion 16 holds, for example, additional image information for printing the additional images 62a, 62b on a A4 size sheet, and additional image information for printing the additional images 79a, 79b on a B5 size sheet.

As described above, additional image information to be added by the image adding portion 16 is fixed at the point that a recording material for recording an image thereon has been fixed at the image recording portion 15. After being subjected to the form conversion, including mode change and demagnification/magnification, the image is processed into a recording image, which is then synthesized with the additional image information preferably just before the generation of execution data. This form of process prevents the formation of additional image information relatively small to an image when the image is subjected to conversion including magnification in particular, thus allows addition of a proper additional image to the image.

Preferably, the image adding portion 16 (or image recording portion 15) has the characteristic judging portion 16e for judging the characteristic of image information input by the image information input portion. The image adding portion 16 determines the form of given additional image information (including the number, position, thickness, size, etc. of the information) according to the characteristic of the image information judged by the characteristic judging portion 16e. This means that the form of given image information to add is fixed according to the characteristic of an image to be recorded/reproduced on a recording material. For example, different pieces of additional image information are added to an image judged to be a photograph image and an image judged to be a character image, respectively. The characteristic judging portion 16e may make judgment as a result of a selection of a photograph mode or a character mode by a user, or in pursuant to a process of reading an image and extracting its characteristic.

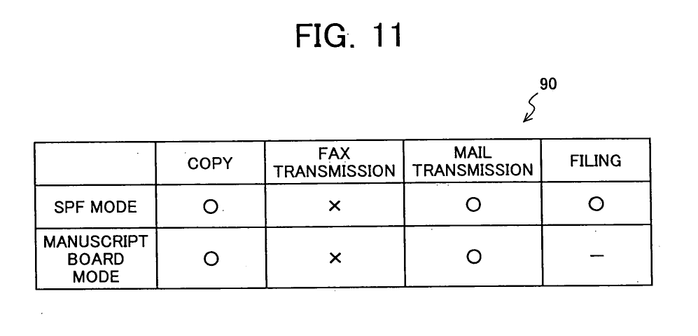

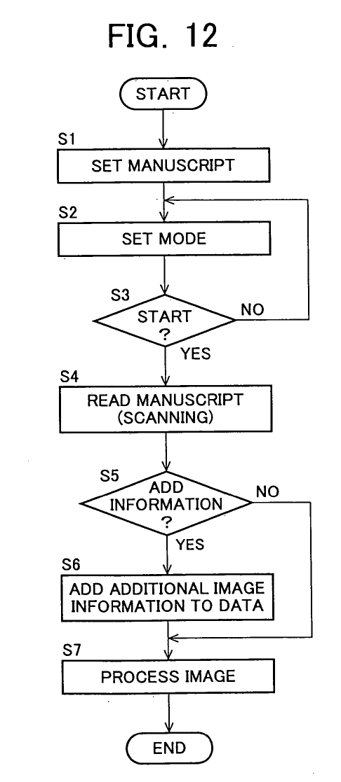

As a supplemental summary of a process flow according to the present invention, one example of a copy process executed by the image forming device is described referring to FIGS. 11, 12. FIG. 11 is a graphic diagram showing one example of a mode-specified addition/non-addition judgment table used in the image forming device of the present invention. Reference numeral 90 in FIG. 11 stands for the table. FIG. 12 is a flowchart for describing a copy process executed by the image forming device of the present invention. FIG. 11 illustrates the table 90 used in the process flow shown in FIG. 12.

The copy process described in reference to FIGS. 11, 12 proceeds as the following. First, setting of a manuscript is confirmed (step S1). A user then makes mode setting, and the image forming device accepts the setting (step S2). The device judges on whether or not the user has pressed the start key (step S3). Judging that the user has not pressed the start key, the device waits for user's pressing at that point, or returns to step S2. Upon confirming user's pressing the start key, the device reads the manuscript (step S4).

Following step S4, the device judges on whether or not to add additional image information (step S5). At step S5, the device makes judgment according to modes set at steps S1, S2. For example, as shown in the-table 90, the device adds the additional image information when the manuscript is set on a SPF (Single Pass Feeder (automatic manuscript feeder) ) at step S1 and the modes set at step S2 consists of a copy mode, an e-mail sending mode, and a filing mode. The device also adds the additional image information when the manuscript is set on the manuscript board at step S1 and the modes set at step S2 consists of the copy mode, and the e-mail sending mode. The device does not add the additional image information regardless of the set position of the manuscript at step S1 when fax transmission is carried out. The process executed according to the table 90 forbids a filing operation on the manuscript board.

Based on a judgment at step S5, the device adds the additional image information to image data (step S6) when necessary, and executes the image forming process (step S7). On the other hand, based on the judgment at step S5, the device does not execute step S6 when unnecessary, and executes the image forming process (step S7).

The image processing apparatus of the present invention is capable of adding an additional image having a high effect of discouragement to an input image when the input image is subjected to image processing, and requires less costs and less time in parts procurement for repair work.

1. An image processing apparatus that executes a given process on image information put into the image processing apparatus, the image processing apparatus comprising:
an image information input portion that inputs image information; and
an image adding portion that adds given visible additional image information for identifying the image processing apparatus to the image information input by the image information input portion, wherein
the image adding portion has a determining portion that determines on whether or not to add the given additional image information to the image information input by the image information input portion.

2. The image processing apparatus as defined in claim 1, the image processing apparatus being an image reading device that reads a manuscript as image information, wherein the image information input portion is a portion that reads the manuscript on a manuscript transfer path.

3. The image processing apparatus as defined in claim 1, the image processing apparatus being an image forming device capable of executing a plurality of image processes as the given process, wherein the image forming device executes respective image processes after the image adding portion has added the given additional image information to the image information input by the image information input portion.

4. The image processing apparatus as defined in claim 1, the image processing apparatus being the image forming device capable of executing a plurality of image processes as the given process, wherein
the image information input portion is the portion that reads the manuscript on the manuscript transfer path,
the image forming device executes respective image processes after the image adding portion has added the given additional image information to the image information input by the image information input portion, and
the determining portion determines on whether or not to add the given additional image information according to the types of the image processes.

5. The image processing apparatus as defined in claim 1, the image processing apparatus being the image forming device capable of executing a plurality of image processes as the given process, wherein
the image information input portion is the portion that reads the manuscript on the manuscript transfer path,
the image forming device executes respective image processes after the image adding portion has added the given additional image information to the image information input by the image information input portion, and
the image adding portion has an additional information determining portion that determines additional image information allowed to be different according to the types of the image processes, the additional image information being provided as the given additional image information, and adds the additional image information determined by the additional information determining portion to the image information.

6. The image processing apparatus as defined in claim 1, wherein the image information input portion has a plurality of input portions that input image information.

7. The image processing apparatus as defined in claim 6, wherein the determining portion determines on whether or not to add the given additional image information according to an input portion operating as a source of input in the image information input portion.

8. The image processing apparatus as defined in claim 6, wherein the image adding portion has the additional information determining portion that determines additional image information allowed to be different according to the input portion operating as the source of input in the image information input portion, the additional image information being provided as the given additional image information, and adds the additional image information determined by the additional information determining portion to the image information input by the image information input portion.

9. The image processing apparatus as defined in claim 6, the image processing apparatus being the image reading device that reads the manuscript as image information, wherein the image information input portion has a first input portion that reads the manuscript on the manuscript transfer path, and a second input portion that reads the manuscript while the manuscript is placed on a manuscript board.

10. The image processing apparatus as defined in claim 6, the image processing apparatus being an image recording device that records the image information input by the image information input portion in a recording medium, wherein the image recording device records the image information input by the image information input portion in the recording medium after the image adding portion has added the given additional image information to the image information.

11. The image processing apparatus as defined in claim 6, the image processing apparatus being the image forming device capable of executing a plurality of image processes as the given process, wherein the image forming device executes respective image processes after the image adding portion has added the given additional image information to the image information input by the image information input portion.

12. The image processing apparatus as defined in claim 6, the image processing apparatus being the image forming device capable of executing a plurality of image processes as the given process, wherein
the image information input portion has a first input portion that reads the manuscript on the manuscript transfer path, and a second input portion that reads the manuscript while the manuscript is placed on the manuscript board,
the image forming device executes respective image processes after the image adding portion has added the given additional image information to the image information input by the image information input portion, and
the determining portion determines on whether or not to add the given additional image information according to the types of the image processes.

13. The image processing apparatus as defined in claim 6, the image processing apparatus being the image forming device capable of executing a plurality of image processes as the given process, wherein
the image information input portion has a first input portion that reads the manuscript on the manuscript transfer path, and a second input portion that reads the manuscript while the manuscript is placed on the manuscript board,
the image forming device executes respective image processes after the image adding portion has added the given additional image information to the image information input by the image information input portion, and
the image adding portion has the additional information determining portion that determines additional image information allowed to be different according to the types of the image processes, the additional image information being provided as the given additional image information, and adds the additional image information determined by the additional information determining portion to the image information input by the image information input portion.

14. The image processing apparatus as defined in claim 13, wherein the additional information determining portion determines additional image information allowed to be different according to the types of the image processes and to the input portion operating as the source of input in the image information input portion, the additional image information being provided as the given additional image information.

15. The image processing apparatus as defined in claim 1, the image processing apparatus having a user authenticating portion that authenticates a user of the image processing apparatus, wherein the image adding portion adds information about the user authenticated by the user authenticating portion in addition to information for identifying the image processing apparatus, both pieces of information being provided as the given additional image information.

16. The image processing apparatus as defined in claim 15, wherein the image adding portion adds the information for identifying the image processing apparatus and the information about the user authenticated by the user authenticating portion, both pieces of information being provided as the given additional image information, so as to place both pieces of information close to each other.

17. The image processing apparatus as defined in claim 15, wherein the image adding portion has an additional information setting portion that allows an administrator of the image processing apparatus who is authenticated by the user authenticating portion to set contents of the given additional image information.

18. The image processing apparatus as defined in claim 17, wherein the contents of the given additional image information, the contents being set using the additional information setting portion, include information about the given process executed on the image information input by the image information input portion in addition to the information for identifying the image processing apparatus.

19. A program to be installed in the image processing apparatus as defined in claim 1, the program causing a control portion of the image processing apparatus to function as the image adding portion.

20. A computer-readable recording medium recording the program as defined in claim 19 therein.
